(19) United States
(12) Patent Application Publication
(10) Pub. No.: US 2019/0227254 A1
(43) Pub. Date: Jul. 25, 2019

(54) TELESCOPE AND FOCUS SHEET

(71) Applicant: Ching-Chou YANG, New Taipei City (TW)

(72) Inventor: Ching-Chou YANG, New Taipei City (TW)

(21) Appl. No.: 15/976,156

(22) Filed: May 10, 2018

(30) Foreign Application Priority Data
Jan. 24, 2018 (TW) 107201178

(51) Int. Cl. G02B 7/04; G02B 23/16

(52) U.S. Cl. CPC G02B 7/04; G02B 23/16

(57) ABSTRACT

A telescope includes a monocular assembly, an optical lens assembly, and a transparent focus sheet. The monocular assembly includes a monocular and a light-shielding tube movably sleeving around the monocular. The optical lens assembly is disposed in the light-shielding tube and is fixed on the monocular. The focus sheet corresponds in position to an end portion of the light-shielding tube. The focus sheet has a first surface and a second surface opposite to and parallel to the first surface. The focus sheet includes a plurality of straight-shaped focus thru-holes, and the focus thru-holes include at least one first thru-hole, at least one second thru-hole and at least one third thru-hole. A longitudinal direction of the first thru-hole and that of the second thru-hole jointly define an angle less than 90 degrees, and a longitudinal direction of the third thru-hole is parallel to an angle bisector of the angle.

### BACKGROUND OF THE DISCLOSURE

### Field of the Disclosure

The present disclosure relates to an optical assembly; in particular, to a telescope and a focus sheet.

### Description of Related Art

When using a conventional telescope (e.g., a monocular telescope), the conventional telescope has to be cooperated with a conventional focus sheet for focusing on an object (e.g., a star). However, the conventional focus sheet is an opaque metallic sheet, thus causing that a focusing effect of an optical device (e.g., a telescope) cooperated with the conventional focus sheet is limited by the conventional focus sheet.

### SUMMARY OF THE DISCLOSURE

The present disclosure provides a telescope and a focus sheet to solve the inadequacies associated with conventional focus sheets.

The present disclosure provides a telescope, which includes a monocular assembly, an optical lens assembly, and a focus sheet. The monocular assembly includes a monocular and a light-shielding tube movably sleeving around the monocular. The optical lens assembly is disposed in the light-shielding tube and is fixed on the monocular. The optical lens assembly includes a hollow cylinder and a plurality of lenses arranged in the cylinder and spaced apart from each other. The focus sheet is substantially transparent and is arranged corresponding in position to an end portion of the light-shielding tube. The focus sheet has a first surface and a second surface opposite to and parallel to the first surface, and the first surface faces the optical lens assembly. The focus sheet includes a plurality of focus thru-holes each being in a straight shape, and the focus thru-holes include at least one first thru-hole, at least one second thru-hole, and at least one third thru-hole. A longitudinal direction of the at least one first thru-hole and that of the at least one second thru-hole jointly define an angle less than 90 degrees, and a longitudinal direction of the at least one third thru-hole is parallel to an angle bisector of the angle. The monocular assembly and the optical lens assembly are configured for focusing on an object by the focus thru-holes of the focus sheet.

Preferably, the telescope further includes a frame detachably fastened to the end portion of the light-shielding tube. The focus sheet includes a circular focus segment and an installing segment arranged outside of the focus segment, and the focus sheet corresponds in position to the end portion by arranging the installing segment on the frame. The focus segment is defined as four quadrants, the focus sheet includes a plurality of focus strips respectively arranged on the four quadrants, and the focus thru-holes are respectively arranged on the four quadrants.

Preferably, the four quadrants include a first quadrant, a second quadrant, a third quadrant, and a fourth quadrant. The focus strips include a plurality of first strips, a plurality of second strips, and a plurality of third strips. The first strips are arranged on the first quadrant and are parallel to each other. One of the first strips is connected to a center of circle of the focus segment. The second strips are arranged on the second quadrant and are parallel to each other. One of the second strips is connected to the center of circle of the focus segment. The third strips are arranged on the third and fourth quadrants and are parallel to each other. One of the third strips is connected to the center of circle of the focus segment. The first strip, the second strip, and the third strip connected to the center of circle of the focus segment are jointly formed as a Y-shaped strip. The focus thru-holes include a plurality of the first thru-holes formed in the first quadrant, a plurality of the second thru-holes formed in the second quadrant, and a plurality of the third thru-holes formed in the third and four quadrants. The first thru-holes are parallel to each of the first strips, the second thru-holes are parallel to each of the second strips, and the third thru-holes are parallel to each of the third strips.

Preferably, each of the third strips other than the Y-shaped strip is connected to one of the first strips or one of the second strips so as to jointly define an obtuse angle. A part of the first strips unconnected to anyone of the third strips are respectively connected to a part of the second strips unconnected to anyone of the third strips, and the connection between each of the part of the first strips and the connected second strip defines an acute angle. The first thru-hole and the second thru-hole arranged adjacent to each other are in spatial communication to jointly define a V-shaped thru-hole, and the focus thru-holes other than the V-shaped thru-hole separate from each other.

Preferably, the focus segment includes a circular strip portion and a ring-shaped mixed portion arranged around the circular strip portion. The circular strip portion has a center of circle overlapped with a center of circle of the focus segment. A ratio between a radius of the focus segment to a radius of the circular strip portion is substantially within a range of 3˜5. A part of the focus strips are arranged on the circular strip portion, and none of the focus thru-holes is arranged on the circular strip portion. The focus thru-holes and the other part of the focus strips are arranged on the ring-shaped mixed portion. An outer end of each of the focus thru-holes overlaps with an outer boundary of the ring-shaped mixed portion, and an inner end of a part of the focus thru-holes overlaps with an inner boundary of the ring-shaped mixed portion.

The present disclosure also provides a focus sheet being substantially transparent. The focus sheet includes a first surface and a second surface opposite to and parallel to the first surface. The focus sheet includes a plurality of focus strips formed on the first surface, and the focus sheet has a plurality of focus thru-holes. The focus strips and the focus thru-holes of the focus sheet are configured for focusing on an object when being applied to an optical device.

Preferably, the focus sheet is defined as a circular focus segment and an installing segment arranged outside of the focus segment. The focus segment includes a circular strip portion and a ring-shaped mixed portion arranged around the circular strip portion. The circular strip portion has a center of circle overlapped with a center of circle of the focus segment. A ratio between a radius of the focus segment to a radius of the circular strip portion is substantially within a range of 3˜5. A part of the focus strips are arranged on the circular strip portion, and none of the focus thru-holes is arranged on the circular strip portion. The focus thru-holes and the other part of the focus strips are arranged on the ring-shaped mixed portion.

Preferably, the focus segment is defined as a first quadrant, a second quadrant, a third quadrant, and a fourth quadrant, which have the same area. The focus strips include a plurality of first strips arranged on the first quadrant and parallel to each other, a plurality of second strips arranged on the second quadrant and parallel to each other, and a plurality of third strips arranged on the third and fourth quadrants and parallel to each other. The focus thru-holes include a plurality of first thru-holes formed in the first quadrant, a plurality of second thru-holes formed in the second quadrant, and a plurality of third thru-holes formed in the third and four quadrants. The first thru-holes are parallel to each of the first strips, the second thru-holes are parallel to each of the second strips, and the third thru-holes are parallel to each of the third strips.

Preferably, one of the first strips is connected to a center of circle of the focus segment, one of the second strips is connected to the center of circle of the focus segment, and one of the third strips is connected to the center of circle of the focus segment. The first strip, the second strip, and the third strip connected to the center of circle of the focus segment are jointly formed as a Y-shaped strip. Each of the third strips other than the Y-shaped strip is connected to one of the first strips or one of the second strips so as to jointly define an obtuse angle. A part of the first strips unconnected to anyone of the third strips are respectively connected to a part of the second strips unconnected to anyone of the third strips, and the connection between each of the part of the first strips and the connected second strip defines an acute angle. The first thru-hole and the second thru-hole arranged adjacent to each other are in spatial communication to jointly define a V-shaped thru-hole, and the focus thru-holes other than the V-shaped thru-hole separate from each other. Any two of the focus strips arranged adjacent to and parallel to each other have an interval, and each of the focus thru-holes has a width that is substantially 2˜8 times of the interval.

The present disclosure further provides a focus sheet being substantially transparent. The focus sheet includes a first surface and a second surface opposite to and parallel to the first surface. The focus sheet includes a plurality of focus thru-holes each being in a straight shape, and the focus thru-holes include at least one first thru-hole, at least one second thru-hole and at least one third thru-hole. A longitudinal direction of the at least one first thru-hole and that of the at least one second thru-hole jointly define an angle less than 90 degrees, and a longitudinal direction of the at least one third thru-hole is parallel to an angle bisector of the angle.

In summary, the telescope of the present disclosure or an optical device can be provided with a good focusing effect by using the transparent focus sheet that has a focusing function by the layout of the focus thru-holes (or the cooperation of the focus thru-holes and the focus strips).

In order to further appreciate the characteristics and technical contents of the present disclosure, references are hereunder made to the detailed descriptions and appended drawings in connection with the present disclosure. However, the appended drawings are merely shown for exemplary purposes, and should not be construed as restricting the scope of the present disclosure.

### BRIEF DESCRIPTION OF THE DRAWINGS

FIG. 1 is a perspective view showing a telescope according to the present disclosure;

FIG. 2 is a cross-sectional view taken along a cross-sectional line II-II of FIG. 1;

FIG. 3 is an exploded view of FIG. 1;

FIG. 4 is a planar view showing a focus sheet according to the present disclosure;

FIG. 5 is a planar view showing the focus sheet in another definition according to the present disclosure; and

FIG. 6 is a planar view showing the focus sheet from another configuration according to the present disclosure.

### DETAILED DESCRIPTION OF THE EXEMPLARY EMBODIMENTS

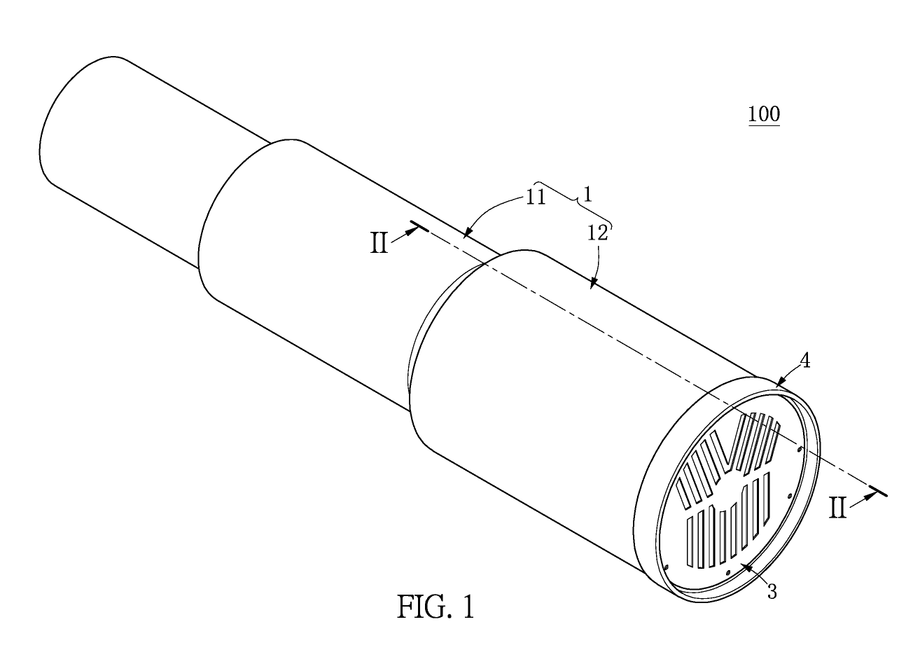

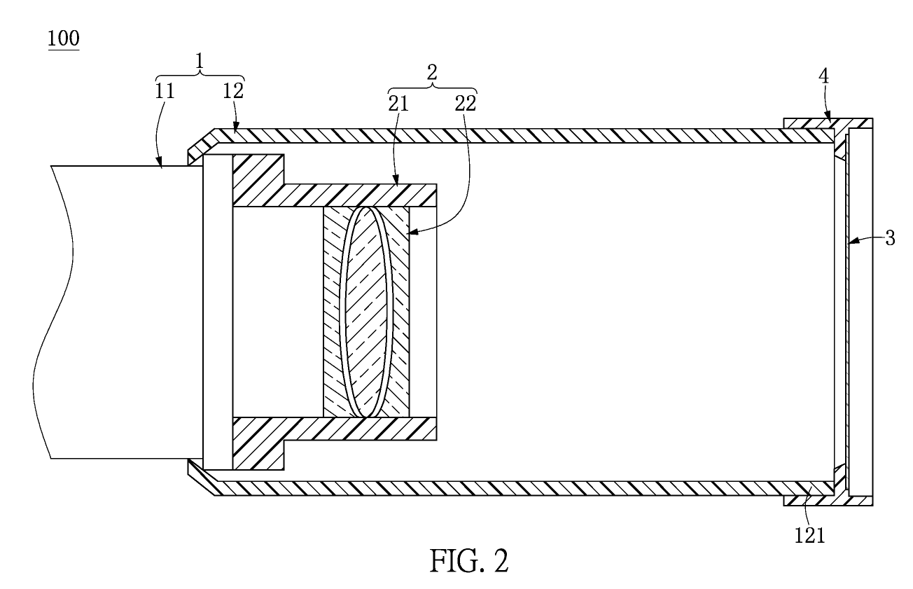

Reference is made to FIGS. 1 to 6, which illustrate an embodiment of the present disclosure. References are hereunder made to the detailed descriptions and appended drawings in connection with the present disclosure. However, the appended drawings are merely provided for exemplary purposes, and should not be construed as restricting the scope of the present disclosure.

As shown in FIGS. 1 to 3, the present embodiment discloses a telescope 100, and the telescope 100 can be a monocular telescope or an astronomical telescope, but the present disclosure is not limited thereto. The telescope 100 includes a monocular assembly 1, an optical lens assembly 2 fastened to an inner side of the monocular assembly 1, and a focus sheet 3 arranged corresponding in position to the monocular assembly 1. Moreover, the telescope 100 in the present embodiment further includes a frame 4 detachably fastened to the monocular assembly 1, such that the focus sheet 3 can be arranged corresponding in position to the monocular assembly 1 by arranging the focus sheet 3 on the frame 4, but the present disclosure is not limited thereto. In other embodiments of the present disclosure, the focus sheet 3 can be directly fastened to a mating component of an optical device.

It should be noted that the focus sheet 3 in the present embodiment is cooperated with the monocular assembly 1, but in other embodiments of the present disclosure, the focus sheet 3 can be applied individually or applied to other optical devices.

As shown in FIGS. 1 to 3, the monocular assembly 1 includes a monocular 11 and a light-shielding tube 12 movably sleeving around the monocular 11, in which the light-shielding tube 12 can also be named as a dew shield. The monocular 11 includes at least one lens (not shown). The light-shielding tube 12 is a hollow structure and is provided without any lenses. The optical lens assembly 2 is disposed in the light-shielding tube 12 and is fixed on the monocular 11. The optical lens assembly 2 includes a hollow cylinder 21 and a plurality of lenses 22 arranged in the cylinder 21 and spaced apart from each other. Moreover, the light-shielding tube 12 is movable in a longitudinal direction of the monocular 11 so as to extend a light channel of the monocular 11, thereby preventing outer lights from interfering with the lenses 22 of the optical lens assembly 2.

The frame 4 is detachably fastened to an end portion 121 of the light-shielding tube 12, and the connection manner between the frame 4 and the light-shielding tube 12 can be adjusted according to design requirements. In the present embodiment, the end portion 121 of the light-shielding tube 12 is directly inserted into the frame 4, and an inner portion of the frame 4 abuts against the end portion 121 of the light-shielding tube 12.

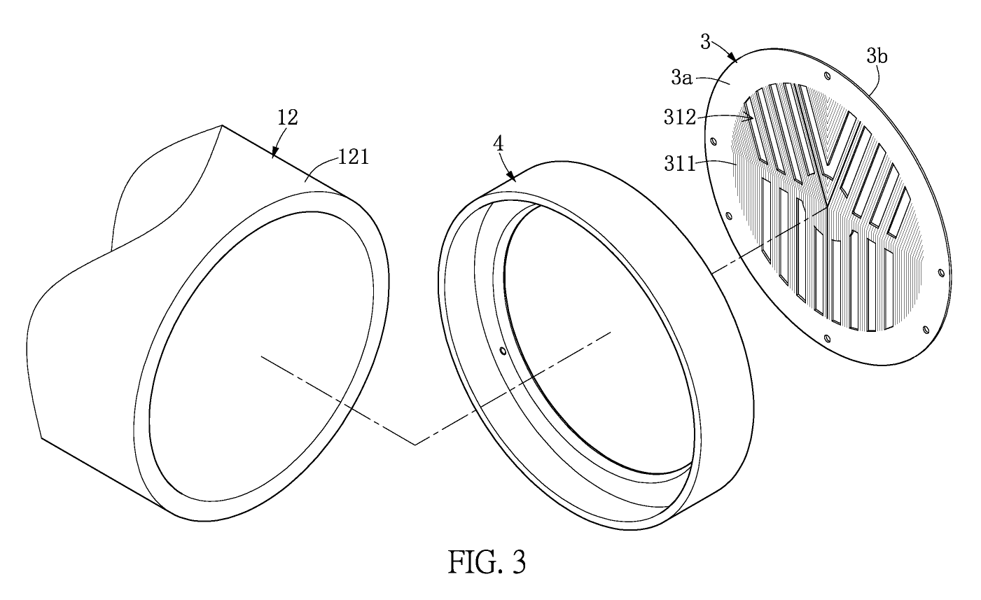

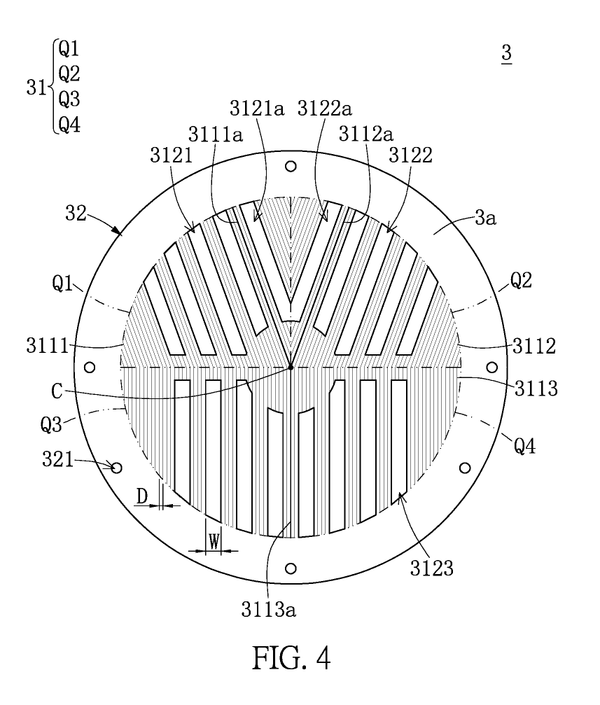

As shown in FIGS. 3 and 4, the focus sheet 3 is substantially transparent and is arranged corresponding in position to the end portion 121 of the light-shielding tube 12 (e.g., the focus sheet 3 is arranged adjacent to the end portion 121). In other words, the focus sheet 3 can be made of a transparent material (e.g., a glass or an acrylic). The focus sheet 3 has a first surface 3a and a second surface 3b opposite to and parallel to the first surface 3a, and the first surface 3a faces the optical lens assembly 2. In the present embodiment, each of the first surface 3a and the second surface 3b is in a planar shape.

Moreover, the focus sheet 3 includes a focus segment 31 and an installing segment 32 arranged outside of the focus segment 31. The installing segment 32 of the focus sheet 3 is detachably positioned to the frame 4, such that the focus sheet 3 can be arranged corresponding in position to the end portion 121 of the light-shielding tube 12 by the cooperation of the installing segment 32 and the frame 4. However, the structure of the frame 4 and the cooperation of the installing segment 32 and the frame 4 can be adjusted according to design requirements, and are not limited by the present embodiment.

In the present embodiment, the frame 4 includes a plurality of positioning structures (not labeled), the installing segment 32 has a plurality of mating structures 321, and the relative position between the focus sheet 3 and frame 4 can be maintained by respectively fastening the mating structures 321 to the positioning structures. Specifically, each of the positioning structures can be a screw, and each of the mating structures 321 can be a thru-hole recessed in the installing segment 32. The focus sheet 3 is fixed on the frame 4 by using the positioning structures (e.g., screws) to pass through the mating structures 321 (e.g., thru-holes), thereby maintaining the relative position between the focus sheet 3 and frame 4.

Moreover, the installing segment 32 in the present embodiment is in a ring shape and is arranged around the focus segment 31, but the present disclosure is not limited thereto. For example, in other embodiments of the present disclosure, the installing segment 32 can include a plurality of sheets in an annular arrangement, and the positioning structures (e.g., screws) are respectively fastened to the sheets of the installing segment 32.

In addition, in other embodiments of the present disclosure, the frame 4 can include a plurality of columns, and the columns of the frame 4 can respectively pass through the installing segment 32 to clamp and position with the end portion 121 of the light-shielding tube 12, such that the focus sheet 3 can be positioned on the end portion 121 by the columns.

The focus sheet 3 includes a plurality of focus strips 311 formed on the first surface 3a, and the focus sheet 3 has a plurality of focus thru-holes 312 each being in a straight shape. The monocular assembly 1 and the optical lens assembly 2 are configured for focusing on an object (e.g., a star) by the focus strips 311 and the focus thru-holes 312 of the focus sheet 3. The size of the focus sheet 3, the specific shape of the focus segment 31, or the specific shape of the focus thru-holes 312 can be adjusted according to design requirements, and is not limited by the present embodiment.

As shown in FIGS. 3 and 4, the focus segment 31 of the focus sheet 3 in the present embodiment is in a circular shape and can be defined as four quadrants Q1˜Q4. The focus strips 311 are respectively arranged on the four quadrants Q1˜Q4, and the focus thru-holes 312 are respectively arranged on the four quadrants Q1˜Q4.

Specifically, the four quadrants Q1˜Q4 of the focus segment 31 include a first quadrant Q1, a second quadrant Q2, a third quadrant Q3, and a fourth quadrant Q4, which have the same area. The focus strips 311 include a plurality of first strips 3111 arranged on the first quadrant Q1, a plurality of second strips 3112 arranged on the second quadrant Q2, and a plurality of third strips 3113 arranged on the third quadrant Q3 and the fourth quadrant Q4.

The first strips 3111 are parallel to each other and have respective lengths, and one of the first strips 3111 (i.e., the first strip 3111a) is connected to a center of circle C of the focus segment 31. The second strips 3112 are parallel to each other and have respective lengths, and one of the second strips 3112 (i.e., the second strip 3112a) is connected to the center of circle C of the focus segment 31. The third strips 3113 are parallel to each other and have respective lengths, and one of the third strips 3113 (i.e., the third strip 3113a) is connected to the center of circle C of the focus segment 31.

Moreover, the first strip 3111a, the second strip 3112a, and the third strip 3113a connected to the center of circle C of the focus segment 31 are jointly formed as a Y-shaped strip. In other words, the first strip 3111a, the second strip 3112a, and the third strip 3113a each have a length that is substantially equal to a radius of the focus segment 31, but the present disclosure is not limited thereto. An angle formed by the first strip 3111a and the second strip 3112a is less than 90 degrees, and an angle formed by the first strip 3111a and the third strip 3113a is more than 90 degrees and is equal to an angle formed by the second strip 3112a and the third strip 3113a.

Furthermore, each of the third strips 3113 other than the Y-shaped strip is connected to one of the first strips 3111 or one of the second strips 3112 so as to jointly define an obtuse angle. A part of the first strips 3111 unconnected to anyone of the third strips 3113 are respectively connected to a part of the second strips 3112 unconnected to anyone of the third strips 3113, and the connection between each of the part of the first strips 3111 and the connected second strip 3112 defines an acute angle.

The focus thru-holes 312 include a plurality of first thru-holes 3121 formed in the first quadrant Q1, a plurality of second thru-holes 3122 formed in the second quadrant Q2, and a plurality of third thru-holes 3123 formed in the third quadrant Q3 and the four quadrant Q4. The first thru-holes 3121 are parallel to each of the first strips 3111, the second thru-holes 3122 are parallel to each of the second strips 3112, and the third thru-holes 3123 are parallel to each of the third strips 3113.

Specifically, the first strips 3111 and the first thru-holes 3121 are in a staggered arrangement, the second strips 3112 and the second thru-holes 3122 are in a staggered arrangement, and the third strips 3113 and the third thru-holes 3123 are in a staggered arrangement. Any two of the focus thru-holes 312 arranged adjacent to and parallel to each other are preferably provided with at least three of the focus strips 311 therebetween (e.g., any two adjacent first thru-holes 3121 are provided with at least three of the first strips 3111 therebeween), but the present disclosure is not limited thereto.

Moreover, any two of the focus strips 311 arranged adjacent to and parallel to each other have an interval D, and each of the focus thru-holes 312 has a width W that is substantially 2˜8 times of the interval D. The width W in the present embodiment is substantially 4˜5 times of the interval D, but the present disclosure is not limited thereto. Each of the focus thru-holes 312 has a length that is smaller than the radius of the focus segment 31.

In the present embodiment, the first thru-hole 3121a and the second thru-hole 3122a arranged adjacent to each other are in spatial communication to jointly define a V-shaped thru-hole that is arranged inside of the first strip 3111a and the second strip 3112a of the Y-shaped strip, and the focus thru-holes 312 other than the V-shaped thru-hole separate from each other, but the present disclosure is not limited thereto.

In addition, the number of each of the first thru-holes 3121, the second thru-holes 3122, and the third thru-holes 3123 is not limited to the present embodiment. In other words, in other embodiments of the present disclosure, the focus thru-holes 312 can include at least one first thru-hole 3121, at least one second thru-hole 3122, and at least one third thru-hole 3123, in which a longitudinal direction of the at least one first thru-hole 3121 and that of the at least one second thru-hole 3122 jointly define an angle less than 90 degrees, and a longitudinal direction of the at least one third thru-hole 3123 is parallel to an angle bisector of the angle. Specifically, the third strip 3113a overlaps with a line that extends along the angle bisector of the angle, and the angle is preferably less than 60 degrees (e.g., 30˜45 degrees), but the present disclosure is not limited thereto.

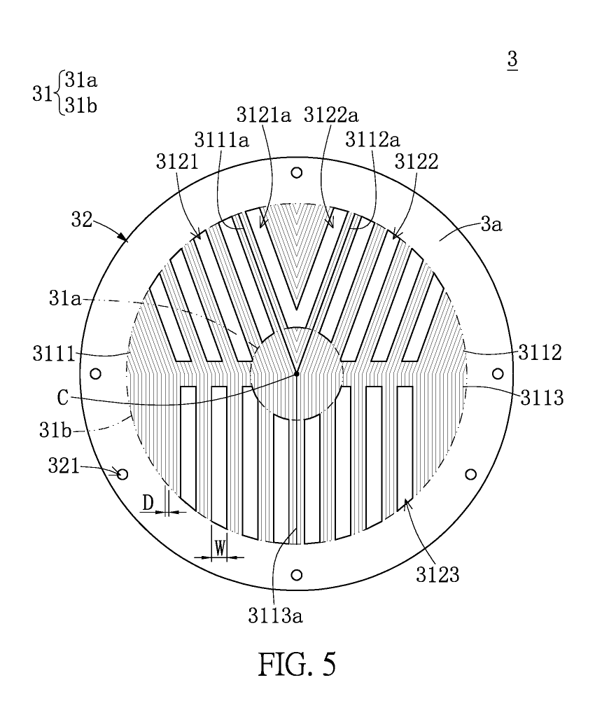

In other words, as shown in FIGS. 4 and 5, the focus segment 31 can also be defined as a circular strip portion 31a and a ring-shaped mixed portion 31b arranged around the circular strip portion 31a. The circular strip portion 31a has a center of circle overlapped with the center of circle C of the focus segment 31, and a ratio between the radius of the focus segment 31 to a radius of the circular strip portion 31a is substantially within a range of 3˜5, but the present disclosure is not limited thereto.

Specifically, a part of the focus strips 311 are arranged on the circular strip portion 31a, none of the focus thru-holes 312 is arranged on the circular strip portion 31a, and the focus thru-holes 312 and the other part of the focus strips 311 are arranged on the ring-shaped mixed portion 31b. Moreover, an outer end of each of the focus thru-holes 312 overlaps with an outer boundary of the ring-shaped mixed portion 31b, and an inner end of a part of the focus thru-holes 312 overlaps with an inner boundary of the ring-shaped mixed portion 31b.

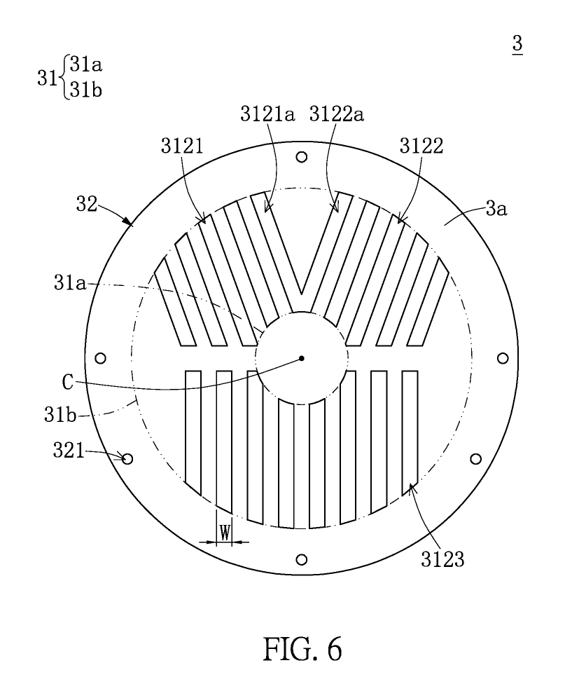

In other embodiments of the present disclosure, the focus sheet 3 can be formed with a circular hole arranged in the circular strip portion 31a, and each of the focus thru-holes 312 does not connect to the circular hole. Moreover, the focus sheet 3 can be only formed with the focus thru-holes 312 as shown in FIG. 6 (that is to say, the focus sheet 3 is provided without any focus strips 311), such that an optical device (e.g., the telescope 100) using the focus sheet 3 can have a good focusing effect by the layout of the focus thru-holes 312.

It should be noted that when a focusing process of the telescope 100 of the present embodiment is implemented by using the focus sheet 3, the object (e.g., star) shows a specific pattern in the telescope 100 (e.g., three clear lines intercrossed at one point), thereby helping the user to determine whether the focusing process is completed or not.

### TECHNICAL EFFECTS OF THE PRESENT EMBODIMENTS

In summary, the telescope of the present disclosure or an optical device can be provided with a good focusing effect by using the transparent focus sheet that has a focusing function by the layout of the focus thru-holes (or the cooperation of the focus thru-holes and the focus strips).

Moreover, the focusing effect of the telescope of the present disclosure (or an optical device) can be further improved by the precise cooperation of the focus thru-holes and the focus strips (e.g., the circular strip portion and the ring-shaped mixed portion; the focus strips and the focus thru-holes in the same quadrant are parallel to each other; Y-shaped strip and V-shaped thru-hole; the width of each of the focus thru-holes is substantially 2˜8 times of the interval between any two adjacent focus strips; any two of the focus thru-holes arranged adjacent to and parallel to each other are provided with at least three of the focus strips therebetween).

The descriptions illustrated supra set forth simply the exemplary embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A telescope, comprising:
a monocular assembly including:
a monocular; and
a light-shielding tube movably sleeving around the monocular;
an optical lens assembly disposed in the light-shielding tube and fixed on the monocular, wherein the optical lens assembly includes a hollow cylinder and a plurality of lenses arranged in the cylinder and spaced apart from each other; and
a focus sheet being substantially transparent and arranged corresponding in position to an end portion of the light-shielding tube, wherein the focus sheet has a first surface and a second surface opposite to and parallel to the first surface, and the first surface faces the optical lens assembly, wherein the focus sheet includes a plurality of focus thru-holes each being in a straight shape, and the focus thru-holes include at least one first thru-hole, at least one second thru-hole, and at least one third thru-hole, wherein a longitudinal direction of the at least one first thru-hole and that of the at least one second thru-hole jointly define an angle less than 90 degrees, and a longitudinal direction of the at least one third thru-hole is parallel to an angle bisector of the angle, and
wherein the monocular assembly and the optical lens assembly are configured for focusing on an object by the focus thru-holes of the focus sheet.

2. The telescope as claimed in claim 1, further comprising a frame detachably fastened to the end portion of the light-shielding tube, wherein the focus sheet includes a circular focus segment and an installing segment arranged outside of the focus segment, and the focus sheet corresponds in position to the end portion by arranging the installing segment on the frame, and wherein the focus segment is defined as four quadrants, the focus sheet includes a plurality of focus strips respectively arranged on the four quadrants, and the focus thru-holes are respectively arranged on the four quadrants.

3. The telescope as claimed in claim 2, wherein the four quadrants include a first quadrant, a second quadrant, a third quadrant, and a fourth quadrant, and the focus strips include:
a plurality of first strips arranged on the first quadrant and parallel to each other, wherein one of the first strips is connected to a center of circle of the focus segment;
a plurality of second strips arranged on the second quadrant and parallel to each other, wherein one of the second strips is connected to the center of circle of the focus segment; and
a plurality of third strips arranged on the third and fourth quadrants and parallel to each other, wherein one of the third strips is connected to the center of circle of the focus segment, and the first strip, the second strip, and the third strip connected to the center of circle of the focus segment are jointly formed as a Y-shaped strip,
wherein the focus thru-holes include a plurality of the first thru-holes formed in the first quadrant, a plurality of the second thru-holes formed in the second quadrant, and a plurality of the third thru-holes formed in the third and four quadrants, and wherein the first thru-holes are parallel to each of the first strips, the second thru-holes are parallel to each of the second strips, and the third thru-holes are parallel to each of the third strips.

4. The telescope as claimed in claim 3, wherein each of the third strips other than the Y-shaped strip is connected to one of the first strips or one of the second strips so as to jointly define an obtuse angle, a part of the first strips unconnected to anyone of the third strips are respectively connected to a part of the second strips unconnected to anyone of the third strips, and the connection between each of the part of the first strips and the connected second strip defines an acute angle, and wherein the first thru-hole and the second thru-hole arranged adjacent to each other are in spatial communication to jointly define a V-shaped thru-hole, and the focus thru-holes other than the V-shaped thru-hole separate from each other.

5. The telescope as claimed in claim 2, wherein the focus segment includes:
a circular strip portion having a center of circle overlapped with a center of circle of the focus segment, wherein a ratio between a radius of the focus segment to a radius of the circular strip portion is substantially within a range of 3˜5, a part of the focus strips are arranged on the circular strip portion, and none of the focus thru-holes is arranged on the circular strip portion; and
a ring-shaped mixed portion arranged around the circular strip portion, wherein the focus thru-holes and the other part of the focus strips are arranged on the ring-shaped mixed portion, an outer end of each of the focus thru-holes overlaps with an outer boundary of the ring-shaped mixed portion, and an inner end of a part of the focus thru-holes overlaps with an inner boundary of the ring-shaped mixed portion.

6. A focus sheet being substantially transparent, comprising: a first surface and a second surface opposite to and parallel to the first surface, wherein the focus sheet includes a plurality of focus strips formed on the first surface, and the focus sheet has a plurality of focus thru-holes, and wherein the focus strips and the focus thru-holes of the focus sheet are configured for focusing on an object when being applied to an optical device.

7. The focus sheet as claimed in claim 6, further being defined as a circular focus segment and an installing segment arranged outside of the focus segment, wherein the focus segment includes:
a circular strip portion having a center of circle overlapped with a center of circle of the focus segment, wherein a ratio between a radius of the focus segment to a radius of the circular strip portion is substantially within a range of 3˜5, a part of the focus strips are arranged on the circular strip portion, and none of the focus thru-holes is arranged on the circular strip portion; and
a ring-shaped mixed portion arranged around the circular strip portion, wherein the focus thru-holes and the other part of the focus strips are arranged on the ring-shaped mixed portion.

8. The focus sheet as claimed in claim 6, wherein the focus segment is defined as a first quadrant, a second quadrant, a third quadrant, and a fourth quadrant, which have the same area, wherein the focus strips include a plurality of first strips arranged on the first quadrant and parallel to each other, a plurality of second strips arranged on the second quadrant and parallel to each other, and a plurality of third strips arranged on the third and fourth quadrants and parallel to each other, wherein the focus thru-holes include a plurality of first thru-holes formed in the first quadrant, a plurality of second thru-holes formed in the second quadrant, and a plurality of third thru-holes formed in the third and four quadrants, and wherein the first thru-holes are parallel to each of the first strips, the second thru-holes are parallel to each of the second strips, and the third thru-holes are parallel to each of the third strips.

9. The focus sheet as claimed in claim 8, wherein one of the first strips is connected to a center of circle of the focus segment, one of the second strips is connected to the center of circle of the focus segment, and one of the third strips is connected to the center of circle of the focus segment, wherein the first strip, the second strip, and the third strip connected to the center of circle of the focus segment are jointly formed as a Y-shaped strip, wherein each of the third strips other than the Y-shaped strip is connected to one of the first strips or one of the second strips so as to jointly define an obtuse angle, a part of the first strips unconnected to anyone of the third strips are respectively connected to a part of the second strips unconnected to anyone of the third strips, and the connection between each of the part of the first strips and the connected second strip defines an acute angle, wherein the first thru-hole and the second thru-hole arranged adjacent to each other are in spatial communication to jointly define a V-shaped thru-hole, and the focus thru-holes other than the V-shaped thru-hole separate from each other, and wherein any two of the focus strips arranged adjacent to and parallel to each other have an interval, and each of the focus thru-holes has a width that is substantially 2˜8 times of the interval.

10. A focus sheet being substantially transparent, comprising: a first surface and a second surface opposite to and parallel to the first surface, wherein the focus sheet includes a plurality of focus thru-holes each being in a straight shape, and the focus thru-holes include at least one first thru-hole, at least one second thru-hole and at least one third thru-hole, wherein a longitudinal direction of the at least one first thru-hole and that of the at least one second thru-hole jointly define an angle less than 90 degrees, and a longitudinal direction of the at least one third thru-hole is parallel to an angle bisector of the angle.
